(19) United States
(12) Patent Application Publication
(10) Pub. No.: US 2024/0201454 A1
(43) Pub. Date: Jun. 20, 2024

(54) FIBER OPTIC CONNECTORS AND FIBER OPTIC CONNECTION SYSTEMS

(71) Applicant: CommScope Technologies LLC, Hickory, NC (US)

(72) Inventors: Patrick Jacques Ann DIEPSTRATEN, Heusden-Zolder (BE); Philippe COENEGRACHT, Hasselt (BE); Johan GEENS, Bunsbeek (BE)

(73) Assignee: CommScope Technologies LLC, Hickory, NC (US)

(21) Appl. No.: 18/556,149

(22) PCT Filed: Apr. 21, 2022
(86) PCT No.: PCT/US2022/025728

§ 371 Date: Oct. 19, 2023

Related U.S. Application Data
(60) Provisional application No. 63/177,782, filed on Apr. 21, 2021.

(51) Int. Cl. G02B 6/38

(52) U.S. Cl. CPC G02B 6/3891; G02B 6/3874

(57) ABSTRACT

The present disclosure relates to an optical connection system including a small-form-factor fiber optic adapter having a robust latching arrangement for securing a fiber optic connector within a connector port of the fiber optic adapter.

### CROSS-REFERENCE TO RELATED APPLICATION

This application is being filed on Apr. 21, 2022 as a PCT International Patent Application and claims the benefit of U.S. Patent Application Ser. No. 63/177,782, filed on Apr. 21, 2021, the disclosure of which is incorporated herein by reference.

### TECHNICAL FIELD

The present disclosure relates generally to fiber optic connectors. More particularly, the present disclosure relates to systems for making fiber optic connectors, and fiber optic connectors made from such systems.

### BACKGROUND

Fiber optic communication systems are becoming prevalent in part because service providers want to deliver high bandwidth communication capabilities (e.g., data and voice) to customers. Fiber optic communication systems employ a network of fiber optic cables to transmit large volumes of data and voice signals over relatively long distances. Optical fiber connectors are an important part of most fiber optic communication systems. Fiber optic connectors allow two optical fibers to be quickly optically connected without requiring a splice. Fiber optic connectors can be used to optically interconnect two lengths of optical fiber. Fiber optic connectors can also be used to interconnect lengths of optical fiber to passive and active equipment.

A typical fiber optic connector includes a ferrule assembly supported at a distal end of a connector housing. A spring is used to bias the ferrule assembly in a distal direction relative to the connector housing. The ferrule functions to support an end portion of at least one optical fiber (in the case of a multi-fiber ferrule, the ends of multiple fibers are supported). The ferrule has a distal end face at which a polished end of the optical fiber is located. When two fiber optic connectors are interconnected, the distal end faces of the ferrules abut one another and the ferrules are forced proximally relative to their respective connector housings against the bias of their respective springs. With the fiber optic connectors connected, their respective optical fibers are coaxially aligned such that the end faces of the optical fibers directly oppose one another. In this way, an optical signal can be transmitted from optical fiber to optical fiber through the aligned end faces of the optical fibers. For many fiber optic connector styles, alignment between two fiber optic connectors is provided through the use of an intermediate fiber optic adapter.

Ruggedized (i.e., hardened) fiber optic connection systems include fiber optic connectors and fiber optic adapters suitable for outside environmental use. These types of systems are typically environmentally sealed and include robust fastening arrangements suitable for withstanding relatively large pull loading and side loading. Example ruggedized fiber optic connection systems are disclosed by U.S. Pat. Nos. 7,467,896; 7,744,288; 8,556,520 and 10,386,584.

It will be appreciated that a number of different types of ruggedized fiber optic connectors are available for outside environmental use. International Publication Nos. WO2015/028433 and WO2021/041305 disclose a system for making fiber optic connectors in which a number of different ruggedized outer assemblies having different form-factors or configurations can be selectively mounted on a pre-terminated cable such that the pre-terminated cable can be customized to be compatible with a particular style or type of fiber optic connector or fiber optic adapter.

### SUMMARY

One aspect of the present disclosure relates to a ruggedized fiber optic adapter having a small form-factor. In one example, the ruggedized fiber optic adapter has a connector latching arrangement that permits single-handed installation of a ruggedized fiber optic connector within the ruggedized fiber optic adapter. In another example, ruggedized fiber optic adapter is configured to allow a plurality of the fiber optic adapters to be mounted in a dense arrangement because finger clearance between the adapters is not required for connector insertion and securement within the adapters.

Another aspect of the present disclosure relates to a fiber optic connection device (e.g., a fiber optic adapter or other connector port defining device) for receiving a fiber optic connector. The fiber optic connection device includes a port-defining body defining a connector port for receiving the fiber optic connector. The fiber optic connection device also includes a resilient latch positioned at least partially within the connector port. The latch is resiliently movable relative to the port-defining body between a connector receiving position, a connector retaining position, and a connector release position. The latch is configured to flex from the connector retaining position to the connector receiving position to accommodate linear insertion of the fiber optic connector into the connector port, and the latch is configured to flex from the connector retaining position to the connector release position to accommodate linear removal of the connector from the connector port. The fiber optic connection device also includes a release sleeve moveable relative to the port-defining body and the resilient latch between a latch retaining position and a latch release position. When the release sleeve is in the latch retaining position the release sleeve prevents the latch from being moved from the connector retaining position to the connector release position and thereby prevents the fiber optic connector from being linearly removed from the connector port. When the release sleeve is in the latch retaining position the release sleeve allows the latch to be moved from the connector retaining position to the connector receiving position and thereby allows the fiber optic connector to be linearly inserted into the connector port. When the release sleeve is in the latch release position the release sleeve does not prevent the latch from being moved from the connector retaining position to the connector release position and thereby allows the fiber optic connector to be linearly removed from the connector port.

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the examples disclosed herein are based.

### BRIEF DESCRIPTION OF THE DRAWINGS

FIG. 1 illustrates a fiber optic connection system in accordance with the principles of the present disclosure;

FIG. 2 is a central cross-sectional view taken lengthwise through the fiber optic connection system of FIG. 1;

FIG. 3 is an exploded view of the fiber optic connection system of FIG. 1;

FIG. 4 is perspective view of an example fiber optic connector of the fiber optic connection system of FIG. 1;

FIG. 5 is another cross-sectional view of the fiber optic connection system of FIG. 1;

FIG. 6 is a perspective end view of an example fiber optic adapter of the fiber optic connection system of FIG. 1;

FIG. 7 is a cross-sectional view though a portion of the fiber optic adapter of FIG. 6 with retention latches in a connector retaining position and a release sleeve in a latch retaining position, the connector port of the fiber optic adapter is not occupied by a fiber optic connector;

FIG. 8 is a cross-sectional view of the fiber optic adapter of FIG. 6 with the fiber optic connector of FIG. 4 shown in the process of being inserted into the connector port of the fiber optic adapter and latches of the fiber optic adapter flexed and pivoted to a connector receiving position via contact with the fiber optic connector, the release sleeve is shown in a latch retaining position;

FIG. 9 is a cross-sectional view of the fiber optic adapter of FIG. 6 with the fiber optic connector of FIG. 4 shown latched within the connector port of the fiber optic adapter, the latches of the fiber optic adapter are shown in connector retaining positions and the release sleeve of the fiber optic adapter is shown in the latch retaining position;

FIG. 10 is a cross-sectional view of the fiber optic adapter of FIG. 6 with the fiber optic connector of FIG. 4 shown in the process of being axially removed from the connector port of the fiber optic adapter and latches of the fiber optic adapter flexed and to a connector release position via contact with the fiber optic connector, the release sleeve is shown in a latch release position;

FIG. 11 is a perspective view of a latch collar of the fiber optic adapter of FIG. 6;

FIG. 12 is another perspective view of the latch collar of the fiber optic adapter of FIG. 6;

FIG. 13 is a side view of the latch collar of the fiber optic adapter of FIG. 6;

FIG. 14 is a top view of the latch collar of the fiber optic adapter of FIG. 6;

FIG. 15 is a perspective view of a release sleeve of the fiber optic adapter of FIG. 6;

FIG. 16 is another perspective view of the release sleeve of the fiber optic adapter of FIG. 6;

FIG. 17 is an end view of the release sleeve of the fiber optic adapter of FIG. 6;

FIG. 18 is a side view of the release sleeve of the fiber optic adapter of FIG. 6;

FIG. 19 is a perspective view of an adapter body of the fiber optic adapter of FIG. 6;

FIG. 20 is another perspective view of the adapter body of the fiber optic adapter of FIG. 6;

FIG. 21 is a top view of the adapter body of the fiber optic adapter of FIG. 6;

FIG. 22 is a side view of the adapter body of the fiber optic adapter of FIG. 6;

FIG. 23 is a perspective view of a first enclosure incorporating ruggedized fiber optic adapters in accordance with the principles of the present disclosure, the enclosure has 1 input port and 4 output ports;

FIG. 24 is a perspective view of a second enclosure incorporating ruggedized fiber optic adapters in accordance with the principles of the present disclosure, the enclosure has 1 input port and 8 output ports;

FIG. 25 is a perspective view of a third enclosure incorporating ruggedized fiber optic adapters in accordance with the principles of the present disclosure, the enclosure has 1 input port and 12 output ports; and

FIG. 26 is a perspective view of a fourth enclosure incorporating ruggedized fiber optic adapters in accordance with the principles of the present disclosure, the enclosure has 1 input port and 16 output ports.

### DETAILED DESCRIPTION

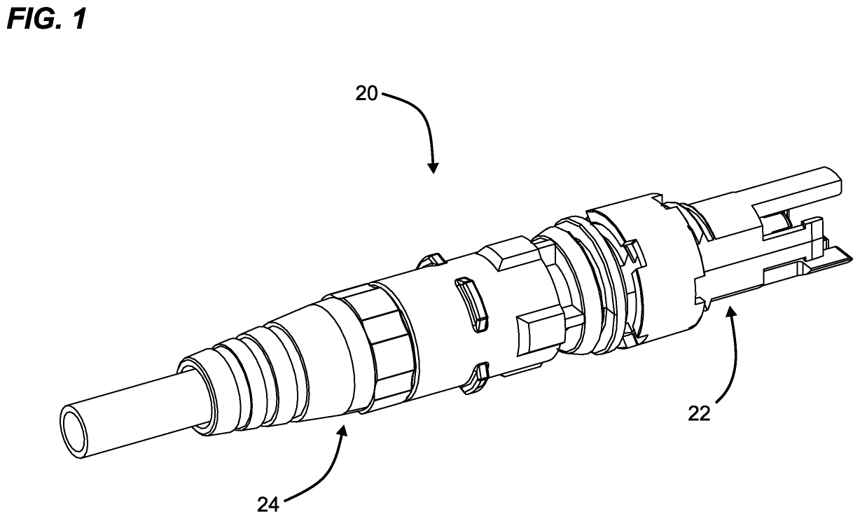

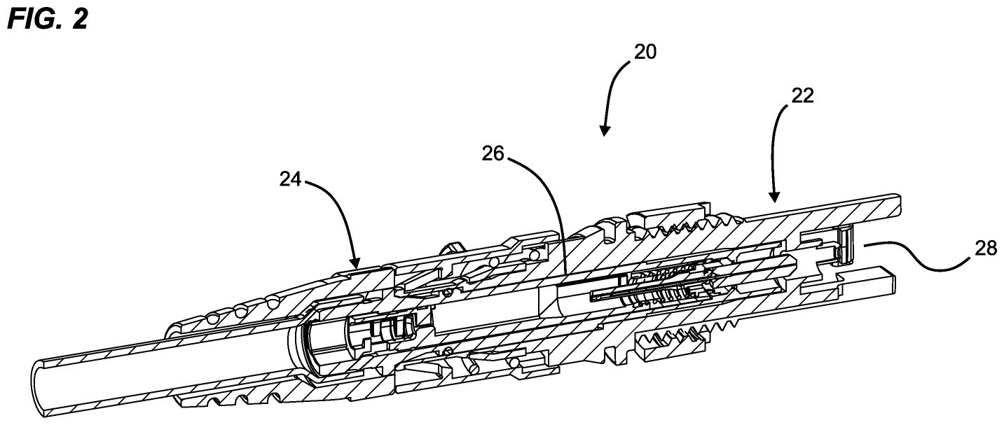

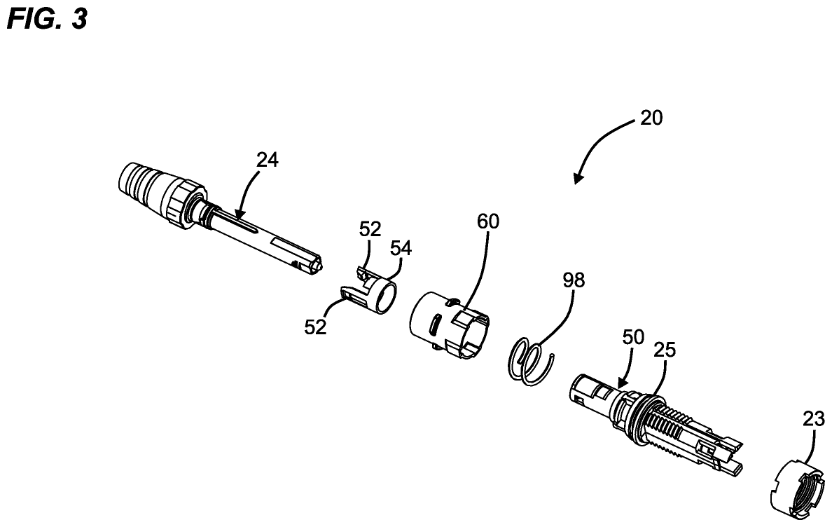

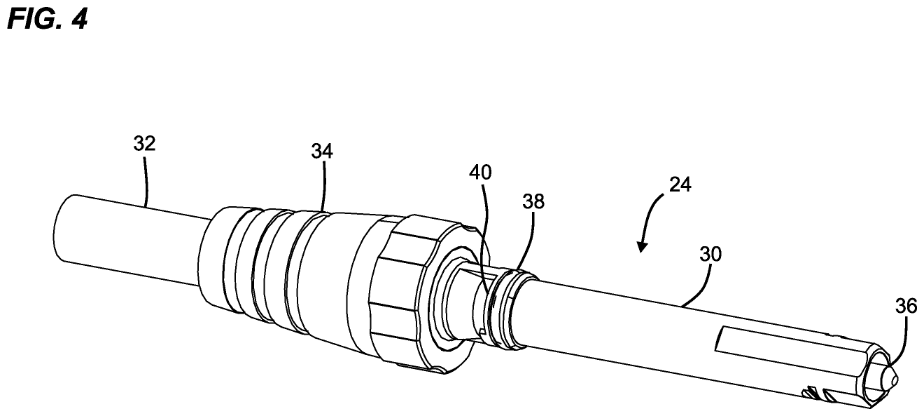

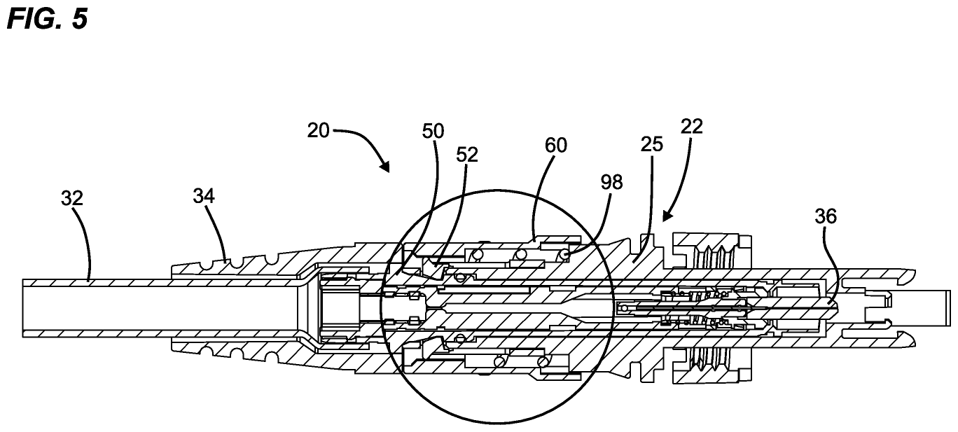

FIGS. 1-3 illustrates an example fiber optic connection system 20 in accordance with the principles of the present disclosure. The fiber optic connection system includes a first fiber optic connection device adapted to mate with a second fiber optic connection device. As depicted, the first fiber optic connection device is a port defining device such as a fiber optic adapter 22 and the second fiber optic connection device is a fiber optic connector 24 adapted to be received within a connector port 26 of the fiber optic adapter 22. In one example, the connector port 26 and the fiber optic connector 24 are hardened and the connector port 26 is environmentally sealed when the fiber optic connector 24 is secured in the connector port 26. In one example, the connection between the fiber optic connector 24 and the fiber optic adapter 22 is sealed and can withstand a pull-out load of at least 25 pounds or at least 50 pounds. In one example, the fiber optic adapter 22 also includes another connector port 28 that is co-axially aligned with the connector port 26. In one example, the connector port 28 is non-hardened and is adapted for receiving a non-hardened connector (e.g., an SC, LC or other non-hardened connector). The fiber optic adapter 22 can include an internal ferrule alignment sleeve for receiving and aligning optical ferrule of the connectors received at the opposite connector ports 26, 28 such that an optical connection is made between the optical fibers corresponding to the fiber optic connection.

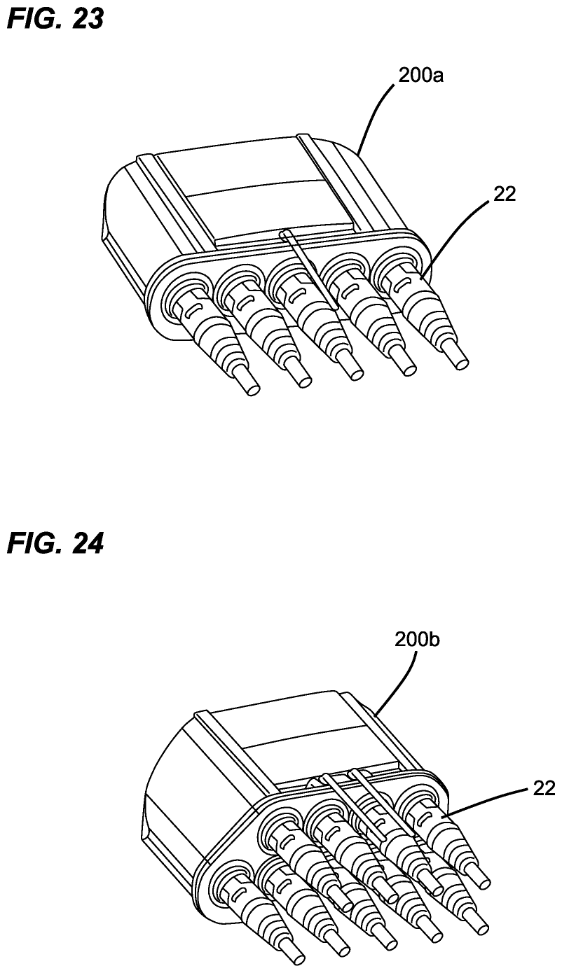

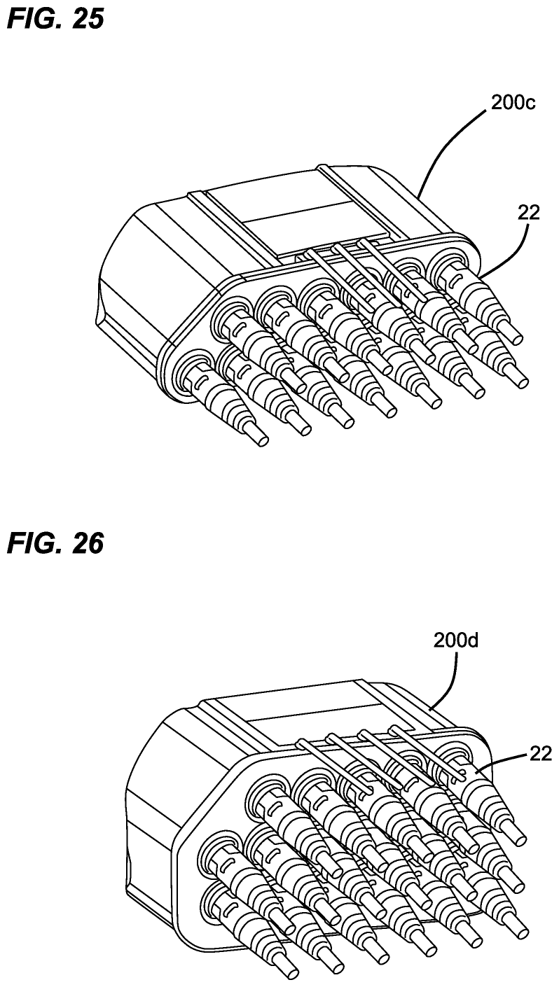

In one example, the fiber optic adapter 22 has a small form factor and is adapted to be secured and sealed within an opening of an enclosure (e.g., via a nut 23 threaded on the adapter body to clamp a wall of the enclosure between the nut and a flange 25 of the adapter body). For example, pluralities of the fiber optic adapters 22 are shown mounted in compact configurations on the enclosures 200a-200d depicted at FIGS. 23-26. The fiber optic adapters 22 each have a connector latching arrangement that permits single-handed installation of a ruggedized fiber optic connector within the ruggedized fiber optic adapter in a single linear motion without requiring manual turning of any locking elements such as threaded nuts or quarter-turn fasteners such as bayonet fasteners. The fiber optic adapter 22 is configured to allow a plurality of the fiber optic adapters to be mounted in a dense arrangement because finger clearance between the adapters is not required for connector insertion and securement within the adapters. In certain examples, the enclosure 200a has a volume less than or equal to 370,000 square millimeters, the enclosure 200b has a volume less than or equal to 600,000 square millimeters, the enclosure 200c has a volume lass than or equal to 900,000 square millimeters, and the enclosure 200d has a volume less than or equal to 1,000,000 square millimeters.

Referring to FIG. 4, the fiber optic connector 24 includes a connector body 30 mounted at the end of a fiber optic cable 32. A flexible boot 34 provides fiber bend protection at the interface between a rear end of the connector body 30 and the fiber optic cable 32. The fiber optic connector 24 includes a ferrule 36 at a front end of the connector body 30 in which an end portion of an optical fiber of the fiber optic cable 32 is secured (e.g., potted). The front portion of the connector body 30 has a form factor compatible with a form factor of the connector port 26 such that the connector body 30 can be inserted into the connector port 26. The fiber optic connector 24 includes a seal 38 for providing a seal with an inner sealing surface of the connector port 26 when the fiber optic connector 24 is secured within the connector port 26. The connector body 30 also includes retention surfaces 40 (e.g., a catches, shoulders, stops, etc.) for engaging a latching arrangement of the fiber optic adapter 22 to retain the connector 24 within the connector port 26. In one example, the retention surfaces 40 are unitarily formed as part of the connector body 30. The latching arrangement of the fiber optic adapter 22 opposes and engages the retention surfaces 40 to retain the fiber optic connector 24 within the connector port 26.

In one example, the connector 24 does not include any active components (e.g., moveable components such as flexible latches, rotatable couplers, slid locks or the like) that are actuated to secure the connector 24 within the connector port 26.

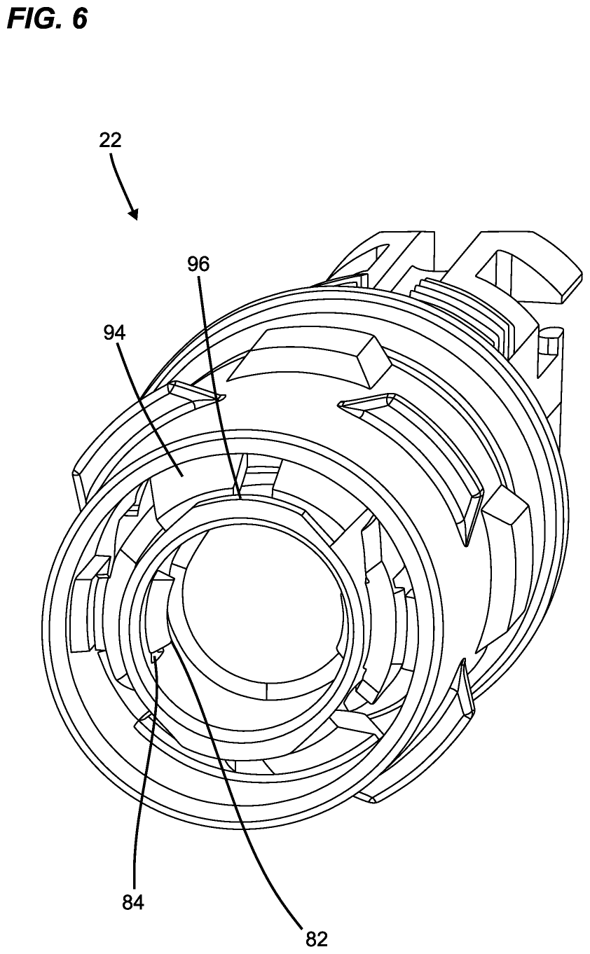

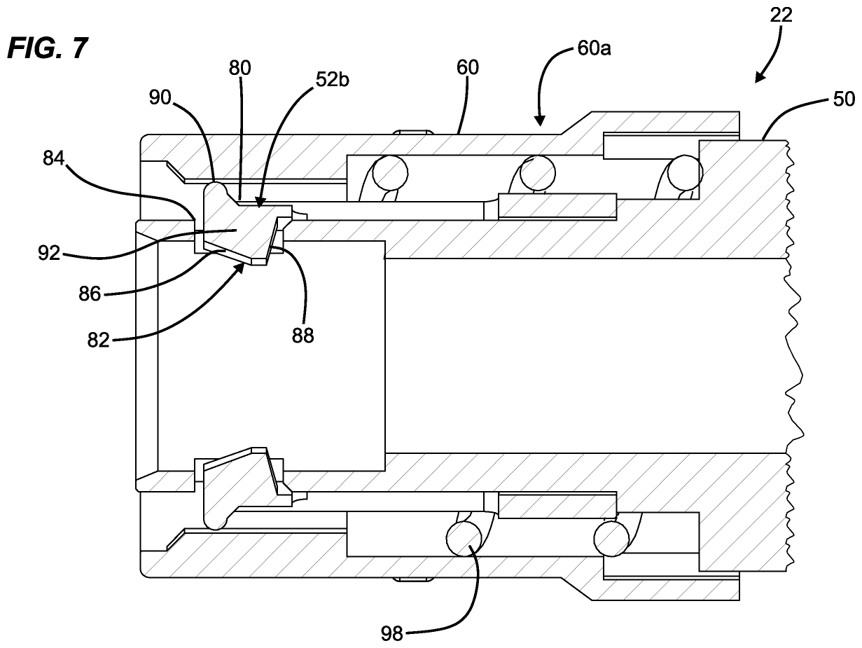

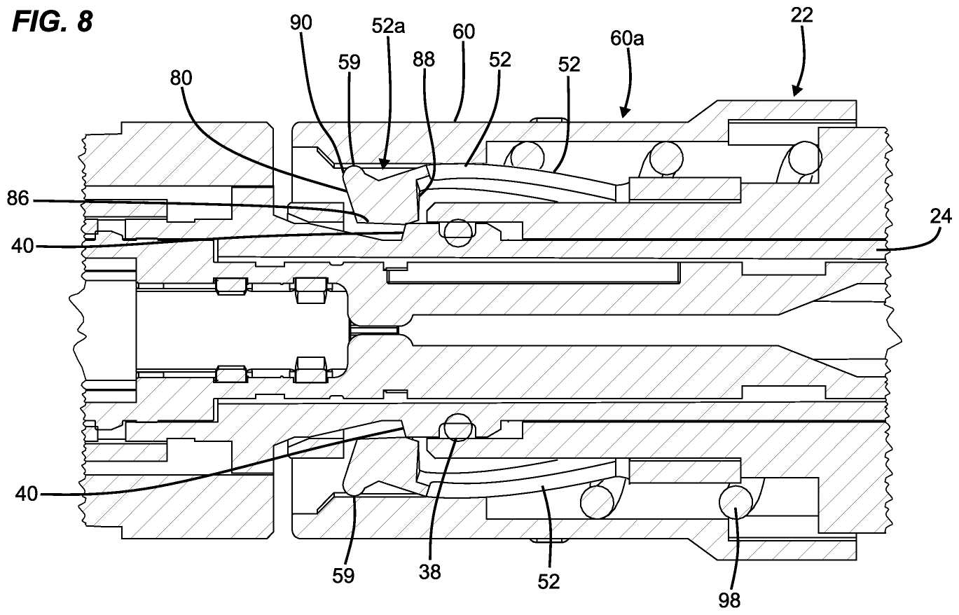

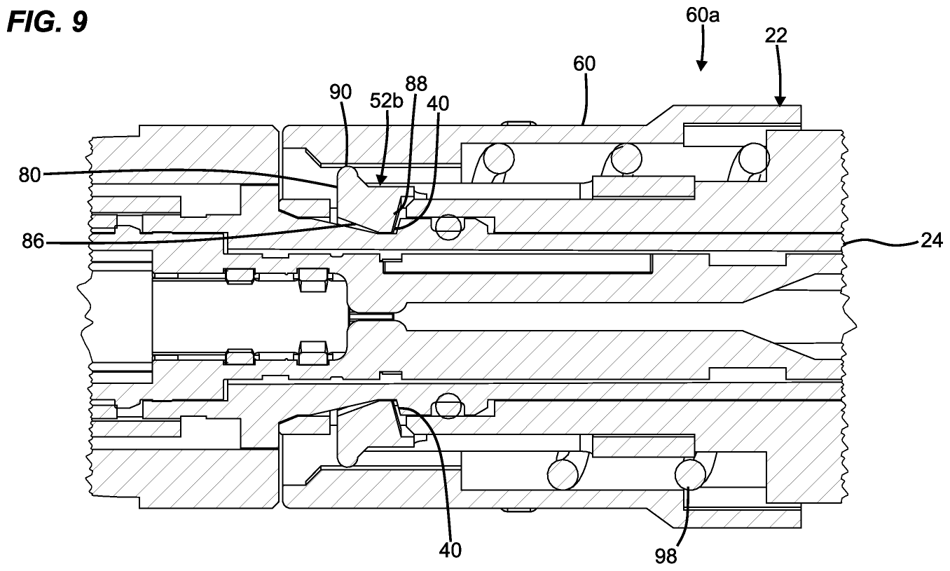

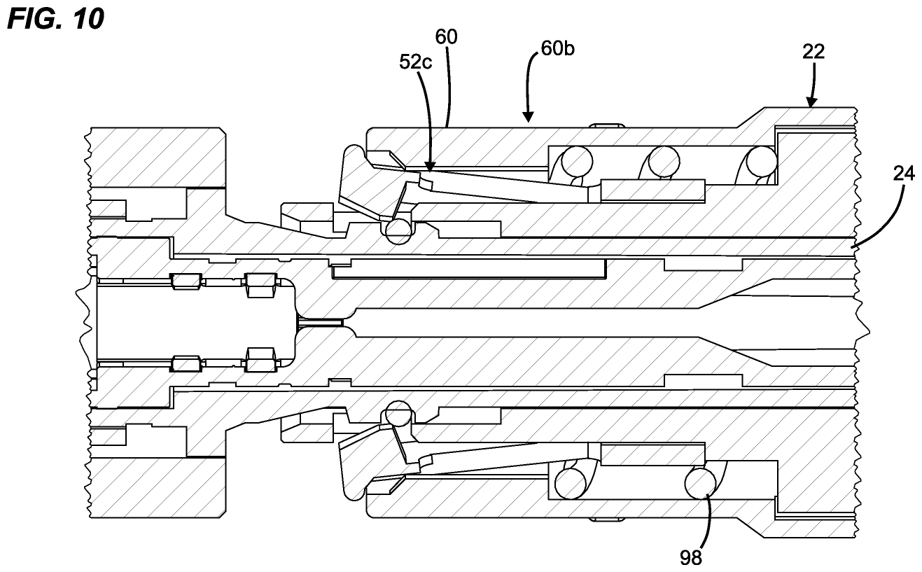

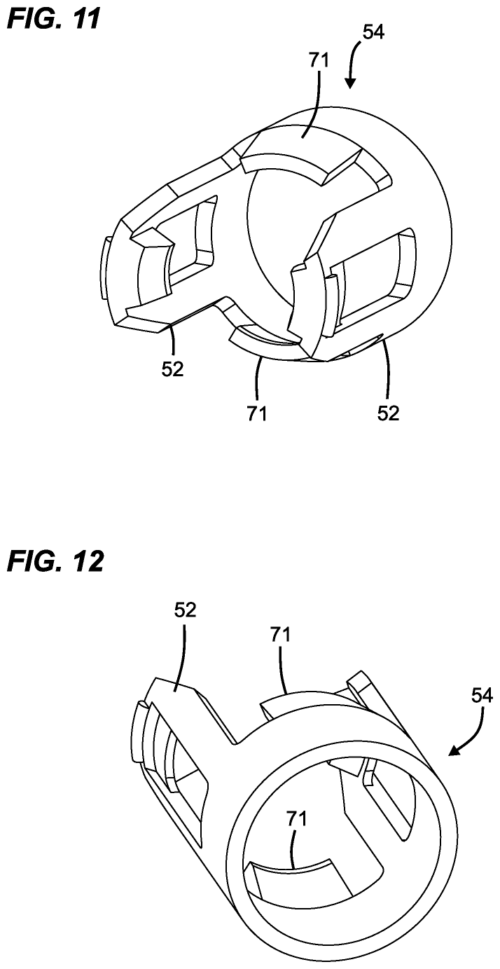

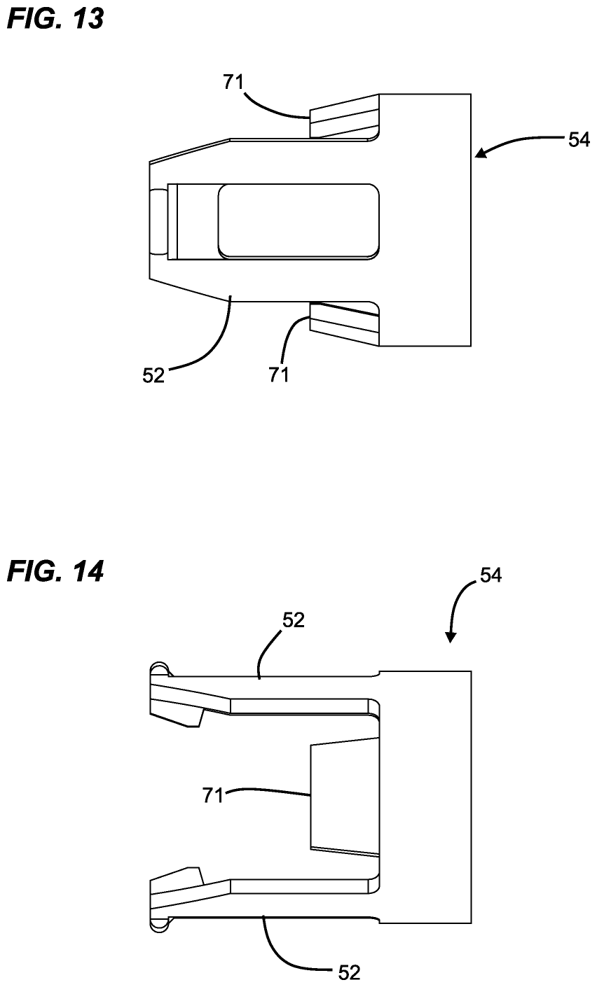

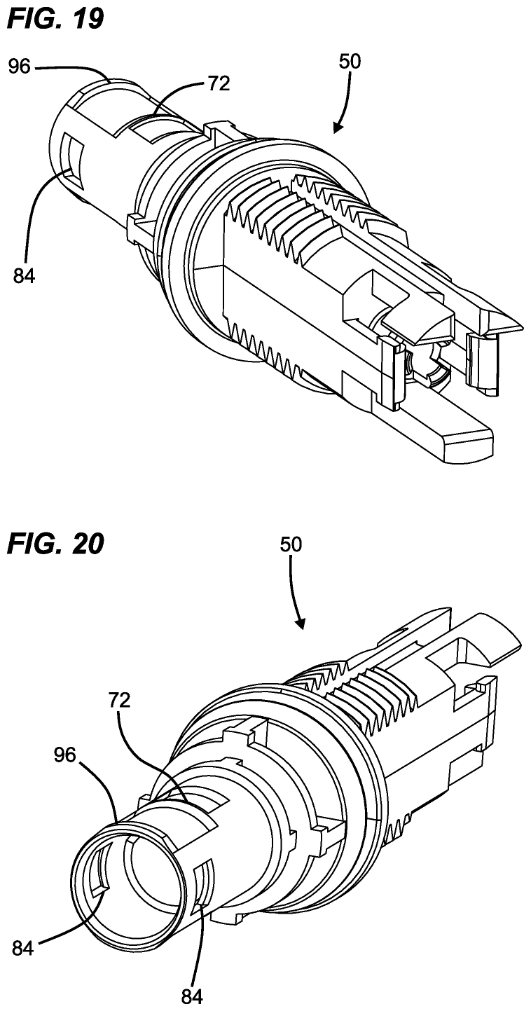

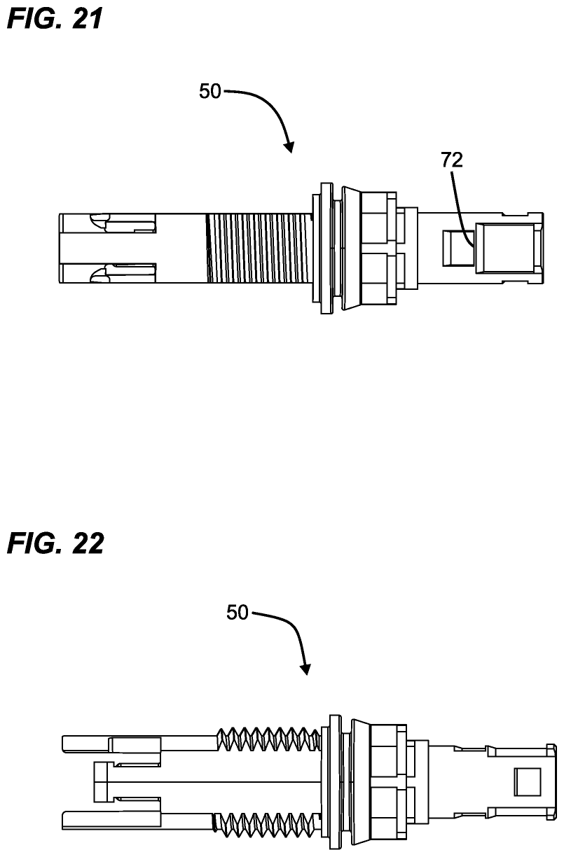

The fiber optic adapter 22 includes a port-defining body 50 (see FIGS. 19-22) defining the connector port 26 for receiving the fiber optic connector 24. The fiber optic adapter 22 also includes a latching arrangement for securing the fiber optic connector 24 within the connector port 26. The latching arrangement includes a plurality of resilient latches 52 that are positioned at least partially within the connector port 26. The resilient latches 52 can be incorporated as part of a latch collar 54 (see FIGS. 11-14). The resilient latches 52 are resiliently movable relative to the port-defining body 50 between a connector receiving position 52a (see FIG. 8), a connector retaining position 52b (see FIGS. 7 and 9), and a connector release position 52c (see FIG. 10). The resilient latches 52 are configured to flex from the connector retaining position 52b to the connector receiving position 52a to accommodate linear insertion of the fiber optic connector 24 into the connector port 26. The resilient latches 52 are configured to flex from the connector retaining position 52b to the connector release position 52c to accommodate linear removal of the connector 24 from the connector port 26.

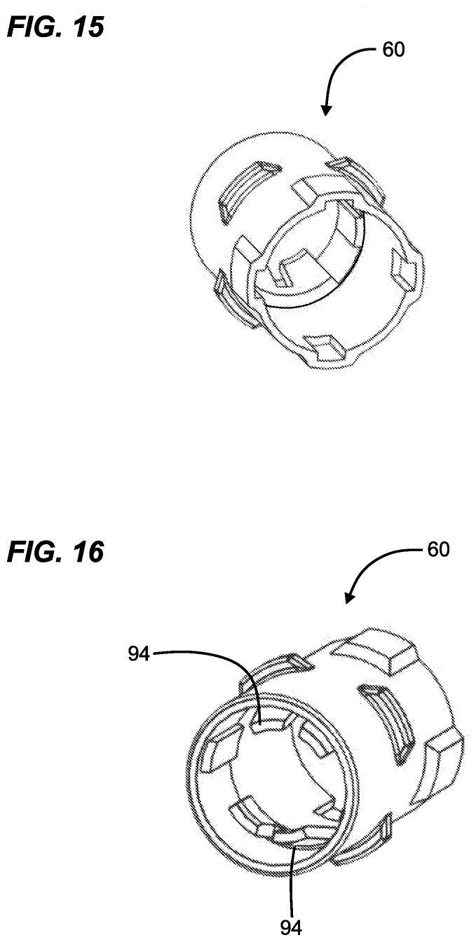

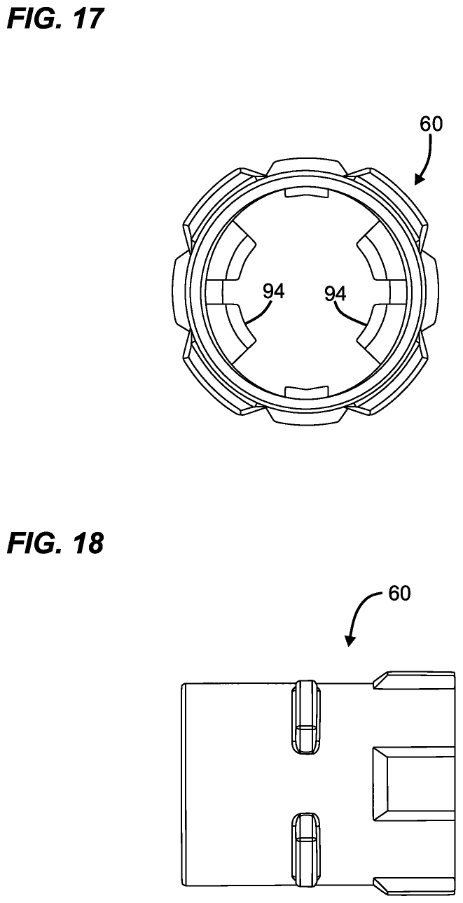

The fiber optic adapter 22 also includes a release sleeve 60 (see FIGS. 15-18) moveable relative to the port-defining body 50 and the latch collar 54 between a latch retaining position 60a (see FIGS. 7-9) and a latch release position 60b (see FIG. 10). When the release sleeve 60 is in the latch retaining position 60a, the release sleeve 60 prevents the resilient latches 52 from being moved from the connector retaining position 52b to the connector release position 52c and thereby prevents the fiber optic connector 24 from being linearly removed from the connector port 26. When the release sleeve 60 is in the latch retaining position 60a, the release sleeve 60 allows the resilient latches 52 to be moved from the connector retaining position 52b to the connector receiving position 52a and thereby allows the fiber optic connector 24 to be linearly inserted into and latched within the connector port 26. In one example, a ramp action between the resilient latches 52 and the connector 24 causes the latches to pivot about pivot points 59 engaging the release sleeve 60 to provide latch clearance for allowing movement of the retention surface 40 of the connector 24 past the resilient latches 52. When the release sleeve 60 is in the latch release position 60b, the release sleeve 60 does not prevent the resilient latches 52 from being moved from the connector retaining position 52b to the connector release position 52c and thereby allows the fiber optic connector 24 to be linearly removed (e.g., pulled) from the connector port 26. For example, when the connector 24 is pulled a ramp action between the connector 24 and the resilient latches 52 moves the resilient latches 52 to the connector release position 52c without obstruction from the release sleeve 60.

In certain examples, the release sleeve 60 and the resilient latches 52 are secured to the port-defining body 50 to form an integrated assembly. In certain examples, the release sleeve 60 and the resilient latches 52 are coupled with the port-defining body 50 to form an integrated fiber optic adapter 22 assembly.

The resilient latches 52 includes a resilient cantilever unitarily formed as part the latch collar 54 which is mounted over an exterior of the port-defining body 50 and under the release sleeve 60. The latch collar 54 is secured to the port-defining body 50 by a snap-fit connection (e.g., see snap tabs 71 that oppose stops 72 on the exterior of the port-defining body 50). The resilient latches 52 include base ends unitarily formed with the latch collar 54 such that the latches project in cantilever fashion axially outwardly from the latch collar 54.

The resilient cantilevers of the resilient latches 52 projects axially along an exterior of the port-defining body 50 from the latch collar 54 and each include a latching head 80 including a latching portion 82 that projects radially inwardly into the connector port 26 through an opening 84 in the port-defining body 50. The latching head 80 includes a ramped connector lead-in surface 86, a connector retention surface 88 and a release sleeve engagement surface 90 positioned about a central location 92 of the latching head 80. The release sleeve engagement surface 90 can engage the release sleeve 60 when the release sleeve 60 is in the latch retaining position 60a and can be rounded to facilitate pivoting of the latching head 80 relative to the connector 24 and the release sleeve 60 when the connector 24 is inserted into the connector port 26. The resilient latches 52 are biased toward the connector retaining position 52b via the inherent resilience of the cantilevers.

When the connector 24 is inserted into the connector port 26 while the resilient latches 52 are in the connector retaining position 52b and the release sleeve 60 is in the latch retaining position 60a, the fiber optic connector 24 engages the ramped connector lead-in surface 86 causing the latching heads 80 to move to the connector receiving position 52a in which the retention surfaces 40 of the fiber optic connector 24 can move axially inwardly past the connector retention surfaces 88 of the latching heads 80. Once the retention surfaces 40 of the connector 24 move past the connector retention surface 88 of the latching heads 80, the latching heads 80 resiliently return to the connector retaining position 52b in which the connector retention surfaces 88 oppose the retention surfaces 40 of the fiber optic connector 24 to latch the fiber optic connector 24 within the connector port 26. If the connector 24 is pulled while the connector 24 is latched in the connector port 26 and the release sleeve 60 is in the latch retaining position 60a, a ramp action between the connector 24 and the latches will drive the release sleeve engagement surfaces 90 against the release sleeve 60 thereby preventing the latches from flexing outwardly and preventing the connector retention surfaces 88 from disengaging from the retention surfaces 40 of the connector 24. The retention sleeve engagement surfaces and the connector retention surfaces 88 of the latching heads 80 are on diametrically opposite sides of the central portions of the latching heads 80.

The resilient latches 52 move from the connector retaining position 52b to the connector receiving position 52a by pivotal movement of latching heads 80 about the pivot points 59 between the release sleeve engagement surface 90 and the release sleeve 60 which causes the connector retention surfaces 88 to move outwardly away from the central axis of the connector port 26 thereby providing clearance for the retention surfaces 40 of the fiber optic connector 24 to move axially inwardly past the connector retention surfaces 88 of the latching heads 80. The pivotal movement of the latching heads 80 are driven by contact between the fiber optic connector 24 and the ramped connector lead-in surfaces 86 of the latching heads 80 and is permitted by outward flexing of the cantilever members of the resilient latches 52.

The release sleeve 60 is retained on the port-defining body 50 by a snap-fit connection (e.g., see snap tabs 94 that engage stops 96 on the exterior of the port-defining body 50) and is axially moveable relative to the port-defining body 50 along the axis of the connector port 26 to move between the latch retaining position 60a and the latch release position 60b. The release sleeve 60 is spring 98 biased by spring 98 toward the latch retaining position 60a. The release sleeve 60 moves in an outward axial direction as the release sleeve 60 moves from the latch release position 60b to the latch retaining position 60a. In certain examples, where finger clearance between adapters is minimal, a tool can be used to push the release sleeve 60 against the bias of the spring 98 from the latch retaining position 60a to the latch release position 60b.

What is claimed is:

1. A fiber optic connection device for receiving a fiber optic connector, the fiber optic connection device comprising:
a port-defining body defining a connector port for receiving the fiber optic connector;
a resilient latch positioned at least partially within the connector port, the latch being resiliently movable relative to the port-defining body between a connector receiving position, a connector retaining position, and a connector release position, wherein the latch is configured to flex from the connector retaining position to the connector receiving position to accommodate linear insertion of the fiber optic connector into the connector port, and wherein the latch is configured to flex from the connector retaining position to the connector release position to accommodate linear removal of the connector from the connector port;
a release sleeve moveable relative to the port-defining body and the resilient latch between a latch retaining position and a latch release position, wherein when the release sleeve is in the latch retaining position the release sleeve prevents the latch from being moved from the connector retaining position to the connector release position and thereby prevents the fiber optic connector from being linearly removed from the connector port, wherein when the release sleeve is in the latch retaining position the release sleeve allows the latch to be moved from the connector retaining position to the connector receiving position and thereby allows the fiber optic connector to be linearly inserted into the connector port, and wherein when the release sleeve is in the latch release position the release sleeve does not prevent the latch from being moved from the connector retaining position to the connector release position and thereby allows the fiber optic connector to be linearly removed from the connector port.

2. The fiber optic connection device of claim 1, wherein the fiber optic connector includes a retention surface that is unitarily formed with a connector body of the fiber optic connector, wherein the latch opposes and engages the retention surface to retain the fiber optic connector within the connector port.

3. The fiber optic connection device of claim 1, wherein the fiber optic connector does not include an active retention structure for retaining the fiber optic connector within the connector port.

4. The fiber optic connection device of claim 1, wherein the release sleeve and the resilient latch are secured to the port-defining body to form an integrated assembly.

5. The fiber optic connection device of claim 1, wherein the release sleeve and the resilient latch are coupled with the port-defining body to form an integrated fiber optic adapter assembly.

6. The fiber optic connection device of claim 1, wherein the resilient latch includes a resilient cantilever unitarily formed with a latch collar mounted over an exterior of the port-defining body and under the release sleeve.

7. The fiber optic connection device of claim 6, wherein the latch collar is secured to the port-defining body by a snap-fit connection, and wherein a plurality of the resilient latches are unitarily formed with and project axially outwardly from the latch collar.

8. The fiber optic connection device of claim 6, wherein the resilient cantilever projects axially along an exterior of the port-defining body from the latching collar and includes latching head including a latching portion that projects radially inwardly through an opening in the port-defining body into the connector port.

9. The fiber optic connection device of claim 8, wherein the latching head includes a ramped connector lead-in surface, a connector retention surface and a release sleeve engagement surface positioned about a central location of the latching head, wherein the resilient latch is biased toward the connector retaining position via an inherent resilience of the cantilever, wherein when the connector is inserted into the connector port while the resilient latch is in the connector retaining position and the release sleeve is in the latch retaining position, the fiber optic connector engages the ramped connector lead-in surface causing the latching head to move to the connector receiving position in which a retention surface of the fiber optic connector can move axially inwardly past the connector retention surface of the latching head, and where when the retention surface of the connector moves past the connector retentions surface of the latching head the latching head resiliently returns to the connector retaining position in which the connector retention surface opposes the retention surface of the fiber optic connector to latch the fiber optic connector within the connector port.

10. The fiber optic connection device of claim 8, wherein the resilient latch moves from the connector retaining position to the connector receiving position by pivotal movement of latching head about a contact location between the release sleeve engagement surface and the release sleeve which causes the connector retention surface to move outwardly away from the central axis of the connector port thereby allowing movement of the retention surface of the fiber optic connector axially inwardly past the connector retention surface of the latching head, and wherein the pivotal movement of the latching head is driven by contact between the fiber optic connector and the ramped lead-in surface of the latching head and is permitted by outward flexing of the cantilever member.

11. The fiber optic connection device of claim 10, wherein the retention sleeve engagement surface and the connector retention surface of the latching head are on diametrically opposite sides of the central portion of the latching head.

12. The fiber optic connection device of claim 1, wherein the release sleeve is retained on the port-defining body by a snap-fit connection and is axially moveable relative to the port-defining body along an axis of the connector port to move between the latch retaining position and the latch release position, and wherein the release sleeve is spring biased toward the latch retaining position.
